(19) United States
(12) Patent Application Publication
(10) Pub. No.: US 2010/0191918 A1
(43) Pub. Date: Jul. 29, 2010

(54) Cache Controller Device, Interfacing Method and Programming Method Using the Same

(75) Inventors: Hwang-Soo Lee, Yuseong-gu (KR); Jung-Keum Kim, Yuseong-gu (KR); Il-Song Han, Yuseong-gu (KR); Young Serk Shim, Yuseong-gu (KR)

Correspondence Address: ABELMAN, FRAYNE & SCHWAB, 666 THIRD AVENUE, 10TH FLOOR, NEW YORK, NY, 10017, US

(73) Assignee: Korea Advanced Institute of Science & Technology

(21) Appl. No.: 12/651,918

(22) Filed: Jan. 4, 2010

(30) Foreign Application Priority Data
Jan. 23, 2009 (KR) 10-2009-0005849

(51) Int. Cl. G06F 12/08; G06F 12/00

(52) U.S. Cl. 711/137; 711/E12.001; 711/E12.057

(57) ABSTRACT

Disclosed are a cache controller device, an interfacing method and a programming method using the same. The cache controller device prefetching and supplying data distributed in a memory to a main processor, includes: a cache temporarily storing data in a memory block having a limited size; a cache controller circularly reading out the data from the memory block to a cache memory, or transferring the data from the cache memory to the cache; and a memory input/output controller controlling prefetching the data to the cache, or transferring the data from the cache to a memory.

### BACKGROUND OF THE INVENTION

1. Field of the Invention

The present invention relates to a cache controller device, an interfacing method and a programming method using the same.

2. Description of the Related Art

In general, cache controller is a device that prefetches data of an adjacent block memory having high possibility required from a program, and provides the fetched data via the fastest memory access cycle when a main processor requires the data, thereby reducing a memory access cycle of the main processor. In the cache operation, a method fetching data adjacent to any memory access block is used.

The operation of a general cache controller considers a feature that data stored in an adjacent memory block can be used frequently in a next instruction execution. That is, the general cache controller previously reads data from an adjacent data block regardless of a use of a program, and provides the data to a main processor upon being used in the program, thereby improving efficiency in a memory access.

However, such an operation causes cache miss when a sequence of data used in a program has a great address difference and is stored in a memory, and a time delay occurs to again read missed data, thereby resulting in cycle consumption. In order to avoid this, great researches on a memory allocation of data rows for efficient use of a memory space as well as the optimization of cycle of a program to be executed in a main processor have been required. In some cases, since the foregoing improvement is impossible, it leads to inevitable consumption of an execution cycle. In other cases, if data required in a program are not continuously distributed to have a great width displacement, cache miss occurs. Consequently, this case can cause a greater penalty than a case where a cache is not used.

### SUMMARY OF THE INVENTION

The present invention has been made in view of the above problems, and it is an object of the present invention to provide a cache controller device, an interfacing method and a programming method using the same that may prevent the occurrence of penalty due to cache miss from a previous fetch of an adjacent memory data having a relatively simple rule being an operation of a conventional cache controller, by rearranging and supplying data rows necessary in a main processor to a cache in a processing order, and continuously transferring the data rows to an original target memory in a background process although the data rows are written into an adjacent memory block in a cache in a write operation of data occurring in the main processor.

It is another object of the present invention to provide a cache controller device, an interfacing method and a programming method using the same that may execute a program of a specific block at optimum speed without the occurrence of cache miss.

It is a further object of the present invention to provide a cache controller device, an interfacing method and a programming method using the same that may improve efficient memory access in a specific program block and efficiency of an execution cycle by using a general cache method prefetching data of a continuous memory, adding a function forcing only data of the location to be efficiently read into a cache memory since it is known a distribution of data necessary in a program block in a case where a general cache method is not rather efficient.

In accordance with an exemplary embodiment of the present invention, there is provided a cache controller device according to claim 1 prefetching and supplying data distributed in a memory to a main processor, comprising: a cache temporarily storing data in a memory block having a limited size; a cache controller circularly reading out the data from the memory block to a cache memory, or transferring the data from the cache memory to the cache; and a memory input/output controller controlling prefetching of the data to the cache, or transferring the data from the cache to a memory.

In a cache controller device of claim 2 according to the cache controller device being claim 1, the cache controller includes: a mode control register controlling converting caching operation into a circular caching operation or converting the circular caching operation into the caching operation by execution of the main processor; a cache map size register defining a size of a block as a target in the circular caching operation to be converted by the execution of the main processor; a cache map address register defining a location of the block as a target in the circular caching operation to be converted by the execution of the main processor; an interface performing synchronization with the memory input/output controller through read and write data counter registers of the cache; and a control logic unit controlling the circular caching operation.

In a cache controller device of claim 3 according to the cache controller device being claim 1, the cache includes: a buffer memory block being simultaneously accessed from the cache controller and the memory input/output controller; and read and write data counter registers accessing synchronization with the cache controller and the memory input/output controller.

In a cache controller device of claim 4 according to the cache controller device being claim 1, the memory input/output controller includes: a read sequence number register defining the number of read data sequence rows; a write sequence number register defining the number of write data sequence rows; a read descriptor ENTRY indicating a start descriptor among read transfer rule descriptors; a write descriptor ENTRY indicating a start descriptor among write transfer rule descriptors; a transfer rule descriptor group defining respective transfer rules of the read data sequence and the write data sequence; and an interface performing synchronization with the cache controller through the read and write data counter registers.

In a cache controller device of claim 5 according to the cache controller device being claim 4, the transfer rule descriptor group includes: a transfer rule descriptor index; a direction filed designating a read mode or a write mode; an indicator field indicating an index of a next data sequence; a number field of a data sequence; a start address field of the data sequence; and an interval field of the data sequence.

An interfacing method of a cache controller device of claim 6 interfacing the cache controller, the memory input/output controller, and the cache map zone upon reading data from a memory to a cache using the cache controller device according to any one of claims 1 to 5, comprises the steps of: (i) rearranging elements of data in a memory location from an interval value of corresponding times from a start address of a read transfer rule descriptor having the same number as the number of contents of a read sequence number register, and reading the elements of the data to the cache by the memory input/output controller; (ii) increasing a value of a read data counter register of the cache and transferring an increase event to the cache controller by the memory input/output controller; (iii) transferring data of the cache to the cache memory; and (iv) reducing a value of the read counter register, and transferring a reduction event to the memory input/output controller to circulate step (i) by the cache controller.

An interfacing method of a cache controller device of claim 7 interfacing the cache controller, the memory input/output controller, and the cache map zone upon writing data from the cache memory to the memory using the cache controller device according to any one of claims 1 to 5, comprises the steps of: (a) preparing data in the cache memory through a program by the main processor; (b) transferring the data from the cache memory to the cache by the cache controller; (c) increasing a value of a write data counter register of the cache and transferring an increase event to the memory input/output controller by the cache controller; (d) rearranging elements of data from an interval value of corresponding times from a start address of a write transfer rule descriptor having the same number as the number of contents of a write sequence number register, and writing the elements of the data to a memory location by the memory input/output controller; and (e) reducing a value of a write data counter register of the cache and transferring a reduction event to the cache controller to be circulated to step (b) by the memory input/output controller.

A programming method of a cache controller device of claim 8 in consideration of a circular cache operation using the cache controller device according to any one of claims 1 to 5, comprises the steps of: producing a read descriptor by data rows necessary in a processing order of a program; producing a write descriptor by data rows output in the processing order of the program; designating a location and a size of a cache to be used in the program; converting an operation of a cache into a circular caching operation by setting the program; and
processing data by referring to a memory location in the cache.

As mentioned above, in a cache controller device, an interfacing method and a programming method using the same according to the present invention, the occurrence of penalty due to cache miss from a previous fetch of an adjacent memory data having a relatively simple rule being an operation of a conventional cache controller may be prevented by rearranging and supplying data rows necessary in a main processor to a cache in a processing order, and continuously transferring the data rows to an original target memory in a background process although the data rows are written into an adjacent memory block in a cache in a write operation of data occurring in the main processor.

Further, the present invention may execute a program of a specific block at optimum speed without the occurrence of cache miss.

Moreover, the present invention may improve efficient memory access in a specific program block and efficiency of an execution cycle by using a general cache method prefetching data of a continuous memory, adding a function forcing only data of the location to be efficiently read into a cache memory since it is known a distribution of data necessary in a program block in a case where a general cache method is not rather efficient.

Specific details other than objects, means for solving the objects, effects are included in following embodiments and drawings. Merits, features, and methods for achieving them of the present invention will be more apparent from the following detailed description in conjunction with the accompanying drawings. In the specification, the same reference numerals are used throughout the drawings to refer to the same or like parts.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a construction of a cache controller device in accordance with an embodiment of the present invention;

FIG. 2 is a block diagram illustrating a rearrangement movement of data between a memory and a cache of the cache controller device in accordance with an embodiment of the present invention;

FIG. 3 is a block diagram illustrating a transfer rule descriptor and a header field in the cache controller device in accordance with an embodiment of the present invention;

FIG. 4 is a block diagram illustrating a data synchronizing procedure in a read operation of the cache controller device in accordance with an embodiment of the present invention;

FIG. 5 is a block diagram illustrating a data synchronizing procedure in a write operation of the cache controller device in accordance with an embodiment of the present invention;

FIG. 6 is a flow chart illustrating a programming method in consideration of a circular cache operation of the cache controller device in accordance with an embodiment of the present invention; and

FIG. 7 is a block diagram illustrating a selective simplified structure of the cache controller device in accordance with an embodiment of the present invention.

### DETAILED DESCRIPTION OF EXEMPLARY EMBODIMENTS

Hereinafter, exemplary embodiments of the present invention are described in detail referring to the accompanying drawings. It will be understood by those skilled in the art that the accompanying drawings have been illustrated for readily explaining the present invention and the present invention is not limited to the drawings.

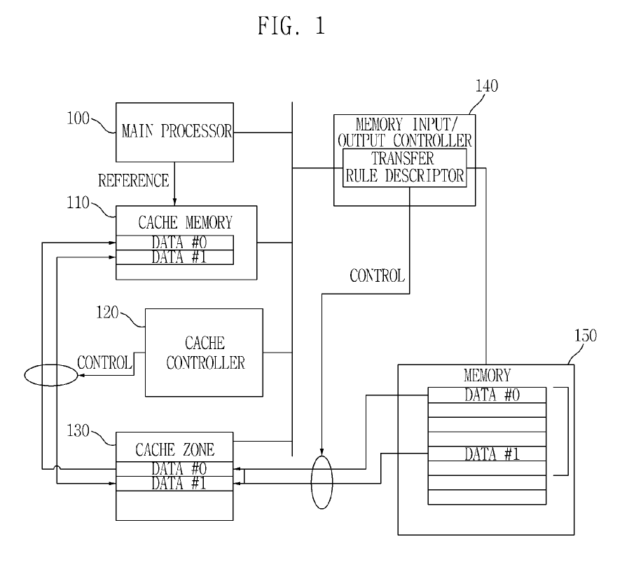

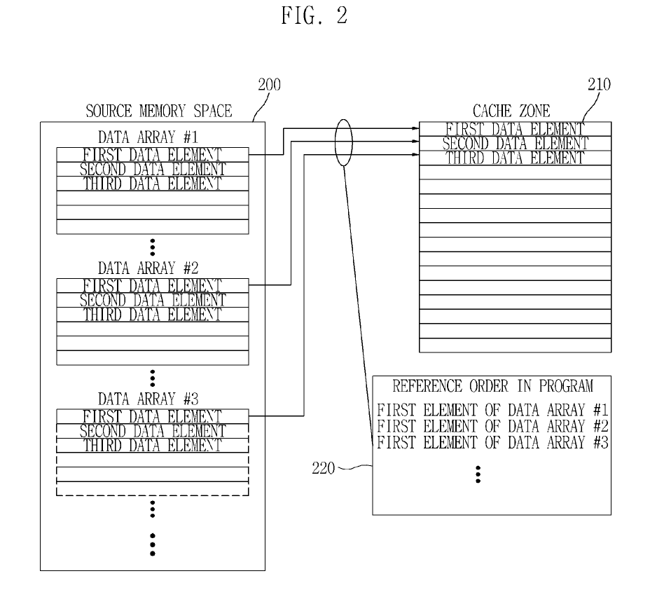

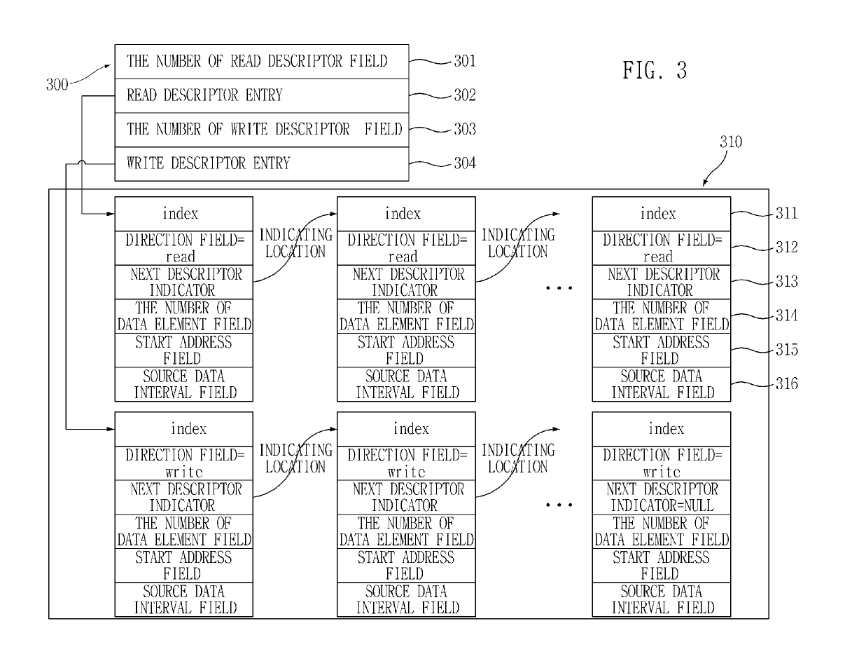

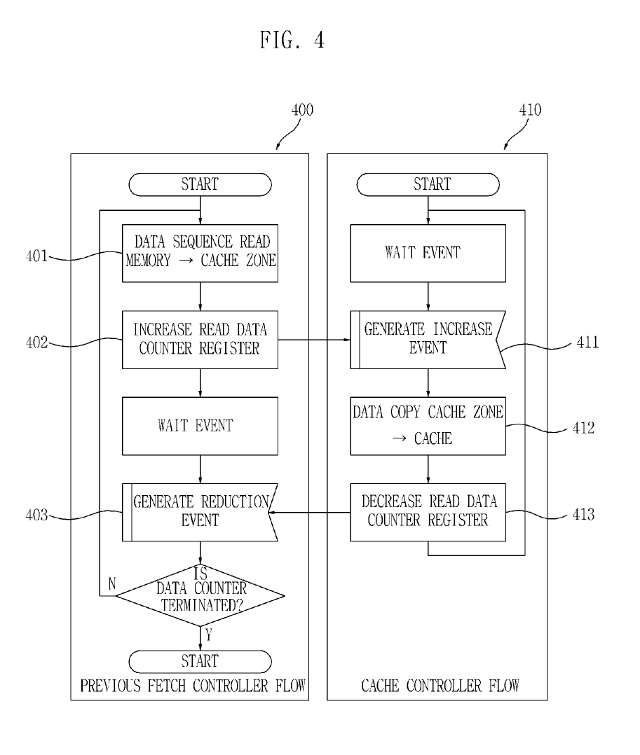

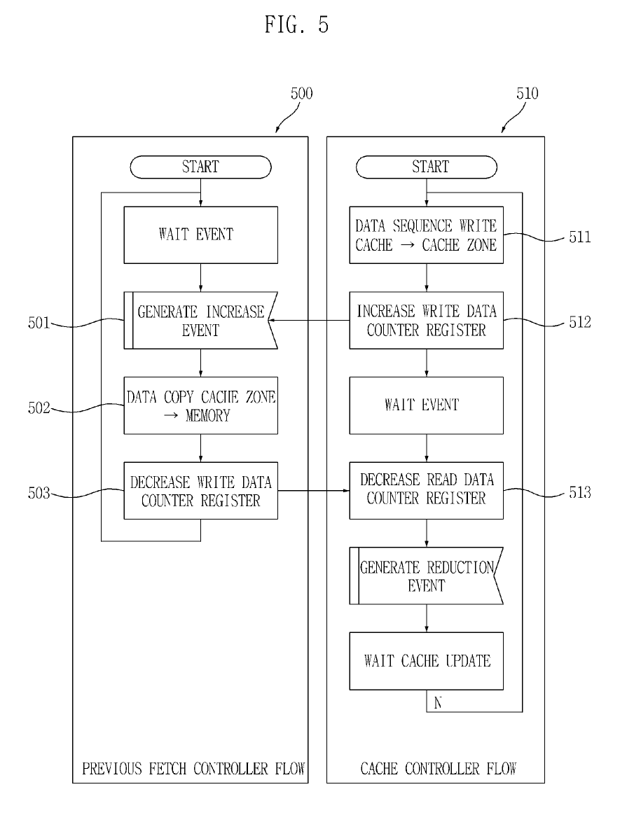

FIG. 1 is a block diagram illustrating a construction of a cache controller device in accordance with an embodiment of the present invention, FIG. 2 is a block diagram illustrating a rearrangement movement of data between a memory and a cache of the cache controller device in accordance with an embodiment of the present invention, FIG. 3 is a block diagram illustrating a transfer rule descriptor and a header field in the cache controller device in accordance with an embodiment of the present invention, FIG. 4 is a block diagram illustrating a data synchronizing procedure in a read operation of the cache controller device in accordance with an embodiment of the present invention, and FIG. 5 is a block diagram illustrating a data synchronizing procedure in a write operation of the cache controller device in accordance with an embodiment of the present invention.

Referring to FIG. 1, the cache controller device prefetching and supplying data distributed in a memory 150 to a main processor 100 includes a cache 130, a cache controller 120, and a memory input/output controller 140.

The cache 130 is a memory block having a limited size, namely, a memory buffer block having a limited size. Preferably, the cache 130 is a block that the cache controller 120 and the memory input/output controller 140 may simultaneously access.

The memory input/output controller 140 controls prefetching and supplying data to the cache 130 or controls moving of the data from the cache 130 to the memory 150. That is, data are copied to the cache 130 in an order described in a transfer rule descriptor during a read operation. At the same time, a simultaneously accessible cache controller 120 transfers data previously copied by a memory accessing device to a cache memory 110 or transfers data written in the cache memory 110 to the cache 130.

Preferably, the cache controller 120 has a function accessing only a cache 130 being a memory buffer of a predetermined size circularly accessing in addition to a general caching operation. In read and write operations of the cache controller 120 from and to the cache 130, it caches a continuously one-dimensional memory block in the same operation in 1-way cache memory 110 being the simplest performing operation of a conventional cache controller 120, but circulates by a size of the cache 130 and accesses the cache 130. Accordingly, the conventional cache controller 120 is characterized by caching a memory block having an area wider than the cache 130. However, the cache controller 120 of the present invention caches only a limited area of the cache 130, and ensures a cache hit in a main processor 100 for data entered in the cache 130.

Namely, the cache controller 120 transfers one-dimensional data stored in a continuous memory block of the cache 130 in a read operation. However, data rows written to the cache 130 are read in a memory 150 in an order referred in a program by the memory input/output controller 140, and rearranged and recorded in the cache 130.

Further, the cache controller 120 and the memory input/output controller 140 further include an interface (not shown) synchronizing data of the cache memory 110. In this case, it is preferred that the interface includes a read/write data transfer counter register (not shown) causing the cache controller 120 to share the cache 130 with the memory input/output controller 140. In this case, the cache controller 120 and the memory input/output controller 140 performs synchronization with the cache memory 110 and the cache 130 via the read/write counter register included in the cache 130.

Accordingly, the cache controller device of the present invention having a structure as described above includes a cache controller 120 for a circular access, a cache map functioning as a space of data for rearrangement, and a memory input/output controller 140 rearranging a data sequence between the cache map and a memory 150 to perform read and write operations. By the construction, the cache controller device maintains a continuous memory access to a limited area, and an additional memory input/output controller 140 rearranges data according to an execution order of a main processor 100 to read or write them.

Referring to FIG. 2, the following is a description of a rearrangement movement of data between a memory and a cache of the cache controller device according to the present invention. When a memory input/output controller 140 copies data in the cache, it rearranges the data by indices of a transfer rule descriptor in an order required in a program by items of plural data sequences 200 previously described in a set step of the program 220, and copies the rearranged data in the cache 210. In this case, the memory input/output controller 140 stores one-dimensional data stored in a continuous memory block 210 of the cache in a write operation in an order processed and output in the program. Upon transferring the one-dimensional data to a real memory, the memory input/output controller rearranges the one-dimensional data by indices of a transfer rule descriptor by items of plural data sequences previously described in the set step of the program, and copies the rearranged data into the memory 200. The memory input/output controller 140 further includes a header area defining a data row sequence necessary in the program, and a unit transfer rule descriptor group by dimensions of the data row sequence.

Referring to FIG. 3, the following is an explanation of a transfer rule descriptor and a header field in the cache controller device according to the present invention. A header area includes a read descriptor number register 301 defining the number of read data sequence rows, a write descriptor number register 303 defining the number of write data sequence rows, a read descriptor ENTRY 302 indicating a start descriptor among read transfer rule descriptors, and a write descriptor ENTRY 304 indicating a start descriptor among write transfer rule descriptors.

Meanwhile, data rows required in a program should refer to a plurality of sequence rows distributed in different memory areas not a simple one-dimensional unit arrangement. A memory input/output controller 140 has a transfer rule descriptor group 310 defining a transfer rule every unit data sequence. Each unit transfer rule descriptor includes a transfer rule descriptor index 311, a direction field designating a read or write mode, an indicator field 313 indicating an index of a next data descriptor, a data element number field 314, a start address field 315 of a data sequence, and an interval field 316 of the data sequence.

In this case, a field of each unit descriptor defines an element distribution rule by arrangements of a source memory space 200, and a mapping rule thereof to a cache. After a start data element of a first descriptor arrangement is mapped to the cache in a reference order 220 in the program of FIG. 2, a next data element is mapped to the cache until elements of an arrangement corresponding to a next data descriptor having an index of an indicator field 313 indicated by a corresponding descriptor repeatedly reach a final descriptor. In this manner, when data of one row are mapped to the cache, corresponding data elements of a second row are repeatedly mapped to the cache until they start from a firs descriptor and repeatedly reach a final descriptor by referring to memory addresses times of rows of an interval field 316 of a data sequence from a start address field 315 of the data sequence.

In a case of a write operation, on the contrary to this, data are mapped from the cache to a source memory space in such a way that rows and columns are transposed. By the foregoing procedure, the memory input/output controller of the present invention provides data area information referring to a program using the transfer rule descriptor, thereby supplying necessary data in a referred order.

Referring to FIG. 4, the following is a data synchronizing procedure in a read operation of the cache controller device according the present invention. Each time data transmission of one unit is terminated in a read operation (step 401), the memory input/output controller 140 increases index data in a read data counter register sharing it with the cache controller 120 (step 402), and produces a read data counter register increase event in the cache controller (step 411). At this time, the cache controller 120 may recognize how much data can read from a cache to a cache through the read data counter register increase event. Further, the cache controller 120 reduces a read data count register (step 413) each time data are transferred to the cache from the cache (step 412). This generates a reduction event of the read data counter register in the memory input/output controller 140 (step 403), and the memory input/output controller 140 transfers a new data sequence.

Referring to FIG. 5, a data synchronizing procedure in a write operation of the cache controller device according to the present invention is described. The cache controller 120 increases a value of a write data counter register (step 512) each time data from a cache memory is transferred to a cache (step 511) in an opposite order of that in a read operation.

The cache controller 120 is activated by a corresponding event (step 501) to transfer data from the cache to a real memory (step 502), and reduces a value of a transfer write data counter register (step 503). The cache controller 120 is activated by a reduction event in a value of the transfer counter register (step 513), thereby transferring a new data sequence entered in a cache memory to the cache.

In the meantime, in a case of a processor including a cache controller, a cache map, and a memory input/output controller of the cache controller device according to the present invention, if data are configured in a different format from that of programming of a conventional cache or a processor without a cache, it can be efficiently executed. Although a method referring to a data row is not different, it should change to a method referring a data row in an order entering in a cache map. Further, a descriptor should be made prior to execution, and a program element setting an operation of a cache should be added.

Meanwhile, in a construction of the cache controller device according to the present invention, some steps can be simplified according to an embodiment selection. The cache and the cache memory may be integrated with each other. The cache controller and a memory accessing device can be implemented by one device. For example, a data path from a memory to a cache memory through a cache can be simplified to a data path from the memory to the cache memory. A reverse data path from the cache memory to the memory through a cache can be simplified to a data path from the cache memory to the memory.

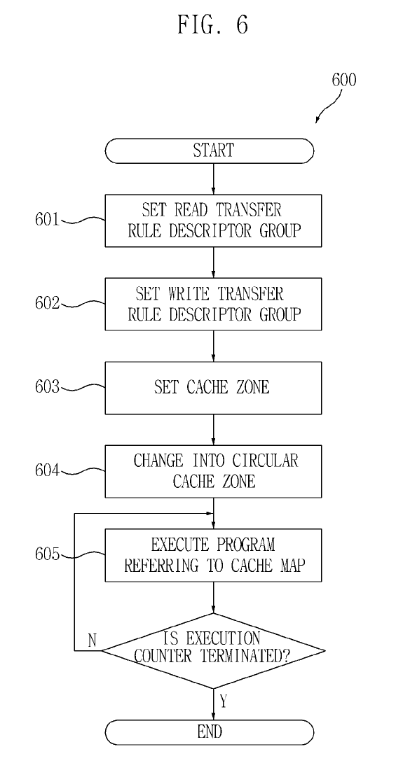

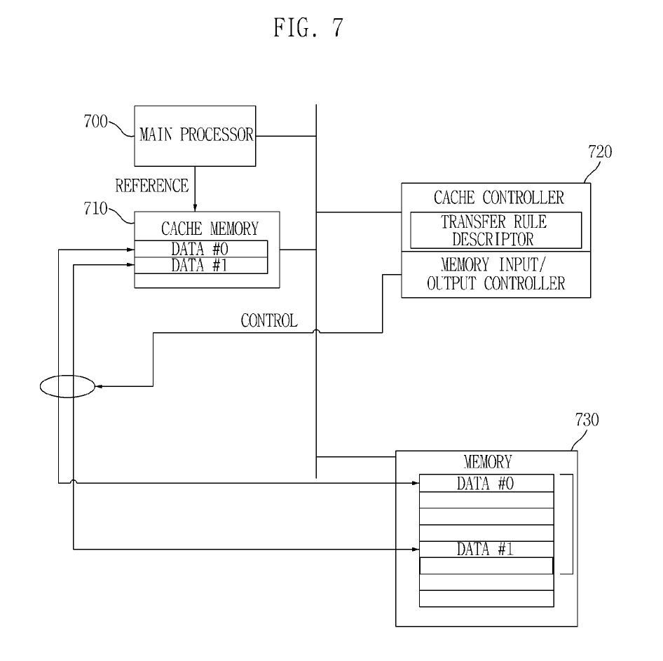

FIG. 6 is a flow chart illustrating a programming method in consideration of a circular cache operation of the cache controller device in accordance with an embodiment of the present invention. FIG. 7 is a block diagram illustrating a selective simplified structure of the cache controller device in accordance with an embodiment of the present invention.

Referring to FIG. 6, the programming method of the cache controller device according to the present invention includes the steps of: producing a read descriptor by data rows necessary in a processing order of a program (step 601); producing a write descriptor by data rows output in the processing order of the program (step 602); designating a location and a size of a cache to be used in the program (step 603); converting an operation of a cache into a circular caching operation by setting the program (step 604); and processing data by referring to a memory location in the cache other than a real data location (step 605). By using the programming method of FIG. 6, a continuous cache hit for a memory is achieved in a program to optimize an efficient programming construction in a memory access.

Referring to FIG. 7, the selective simplified structure of the cache controller device in accordance with another embodiment of the pre sent invention will be described. A cache memory 710 may control a data path by omitting a path of a cache, and transferring data rearranged directly in a memory 730 or transferring data rearranged directly in the cache memory 710 to the memory 730, by the cache controller and the memory input/output controller 720 logically and physically connected to each other. This implementation is another embodiment of the present invention as mentioned above.

Accordingly, in the cache controller device, the interfacing method and a programming method using the same according to the present invention, a reference of read data of a main processor may maintain a read cache hit rate of 100% as long as a cycle of a memory input/output device is not late because data in an order required in the main processor are always prepared in the faster cache memory. Meanwhile, in a case of a writ operation, since data are only written into a cache being a continuous memory block, a write cache hit rate may maintain 100%. Further, because a memory input/output device other than a cache controller performs rearrangement, accessing a real memory address can reduce an execution load of the main processor.

Although embodiments in accordance with the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A cache controller device prefetching and supplying data distributed in a memory to a main processor, comprising:
a cache for storing a data temporarily in a memory block having a limited size;
a cache controller for reading out the data from the memory block to a cache memory, or transferring the data from the cache memory to the cache; and
a memory input/output controller for causing the cache to prefetch the data to the cache, or for causing the cache to transfer the data cache to a memory.

2. The cache controller device according to claim 1, wherein the cache controller includes:
a mode control register for changing caching operation into a circular caching operation, or to change the circular caching operation into the caching operation;
a cache map size register for setting a size of a target block in the circular caching operation;
a cache map address register for setting a location of the target block in the circular caching operation;
an interface for synchronizing the memory input/output controller with read and write data counter registers of the cache; and
a control logic unit for controlling the circular caching operation.

3. The cache controller device according to claim 1, wherein the cache includes:
a buffer memory for being accessed from the cache controller and the memory input/output controller; and
read and write data counter registers for being accessed synchronously by the cache controller and the memory input/output controller.

4. The cache controller device according to claim 1, wherein the memory input/output controller comprises:
a read sequence number register for setting the number of read data sequence rows;
a write sequence number register for setting the number of write data sequence rows;
an entry of read descriptor for indicating a start descriptor among read transfer rule descriptors;
an entry of write descriptor for indicating a start descriptor among write transfer rule descriptors;
a plurality of transfer rule descriptor for setting respective transfer rules of the read data sequence and the write data sequence; and
an interface for synchronizing the cache controller with the read and write data counter registers.

5. The cache controller device according to claim 4, wherein the transfer rule descriptor comprises:
a transfer rule descriptor index;
a direction field for indicating a read mode or a write mode;
an indicator field for indicating an index of a next data sequence;
a number field of a data sequence;
a start address field of the data sequence; and
an interval field of the data sequence.

6. An interfacing method of a cache controller device interfacing the cache controller, the memory input/output controller, and the cache map zone upon reading data from a memory to a cache using the cache controller device, the method comprising
rearranging elements of data in a memory location from an interval value of corresponding times from a start address of a read transfer rule descriptor having the same number as the number of contents of a read sequence number register, and reading the elements of the data to the cache by the memory input/output controller;
increasing a value of a read data counter register of the cache and transferring an increase event to the cache controller by the memory input/output controller;
transferring data of the cache to the cache memory; and
reducing a value of the read counter register, and transferring a reduction event to the memory input/output controller by the cache controller.

7. An interfacing method of a cache controller device interfacing the cache controller, the memory input/output controller, and the cache map zone upon writing data from the cache memory to the memory using the cache controller device, the method comprising:
preparing data in the cache memory through a program by the main processor;
transferring the data from the cache memory to the cache by the cache controller;
increasing a value of a write data counter register of the cache and transferring an increase event to the memory input/output controller by the cache controller;
rearranging elements of data from an interval value of corresponding times from a start address of a write transfer rule descriptor having the same number as the number of contents of a write sequence number register, and writing the elements of the data to a memory location by the memory input/output controller; and
reducing a value of a write data counter register of the cache and transferring a reduction event to the cache controller by the memory input/output controller.

8. A method of a cache controller device in consideration of a circular cache operation using the cache controller device according to claim 1, the method comprising:
producing a read descriptor by data rows necessary in a processing order of a program;
producing a write descriptor by data rows output in the processing order of the program;
designating a location and a size of a cache to be used in the program;
changing an operation of a cache into a circular caching operation by setting the program; and
processing data by referring to a memory location in the cache.
